(19) United States
(12) Patent Application Publication
(10) Pub. No.: US 2002/0068684 A1
(43) Pub. Date: Jun. 6, 2002

(54) Stripping and cleaning compositions

(76) Inventors: Darryl W. Peters, Stewartsville, NJ (US); Floyd L. Riddle JR., Hellertown, PA (US)

Correspondence Address: John Lezdey, 1409 SUITE A NORTH FT HARRISON, CLEARWATER, FL, 33755, US

(21) Appl. No.: 09/929,158

(22) Filed: Aug. 14, 2001

Related U.S. Application Data
(63) Continuation-in-part of application No. 09/377,398, filed on Aug. 19, 1999, now abandoned.

(51) Int. Cl. C11D 1/00

(52) U.S. Cl. 510/175; 510/176; 510/178

(57) ABSTRACT

There is provided corrosion inhibitors for aqueous stripping and/or cleaning compositions containing organic polar solvents. The inhibitors are aliphatic dicarboxylic acid compounds or their anhydrides. The inhibitors can be utilized in compositions which are free of oxidizing agents and in basic stripping and cleaning compositions.

### RELATED APPLICATION

This application is a continuation-in-part of application Ser. No. 09/377,398 filed Aug. 19, 1999.

### FIELD OF THE INVENTION

The present invention relates to basic stripping and cleansing compositions containing novel corrosion inhibitors. More particularly, there is provided aliphatic dicarboxylic acid compounds which are useful as corrosion inhibitors in compositions which are free of oxidizing agents and basic stripping and cleansing compositions, particularly for removal of photoresists and residues from substrates

### BACKGROUND OF THE INVENTION

During the manufacture of semiconductors and semiconductor microcircuits, it is frequently necessary to coat the substrates from which the semiconductors and microcircuits are manufactured with a polymeric organic film, generally referred to as a photoresist, e.g., a substance which forms an etch resist upon exposure to light. These photoresists are used to protect selected areas of the surface of the substrate, while the etchant selectively attacks the unprotected area of the substrate.

The substrate is typically a silicon dioxide coated silicon wafer and may also contain metallic microcircuitry, such as aluminum or alloys, on the surface. Following completion of the etching operation and washing away of the residual etchant, it is necessary that the resist be removed from the protective surface to permit essential finishing operations. It is desirable to develop an improved stripping composition to remove the organic polymeric substrate from a coated inorganic substrate without corroding, dissolving, or dulling the metal circuitry or chemically altering the wafer substrate.

Presently used metal corrosion inhibitor additives for photoresistant strippers are aromatic compounds such as phenol derivatives, catcheol, pyrogallol, gallic acid and the like, which do not maintain corrosion inhibition in compositions containing more than 25 percent by weight of water, especially for aluminum and aluminum and copper substrates. However, high water content improves the cleaning of the substrates to remove inorganic residue.

Phenols and hydroxyphenols are weak acids which deprotonate in solutions with a pH above about 9, forming mono- and di-anione which can chelate with metal cations forming five, six, and seven membered rings. Since they do not deprotonate at lower pH values, they do not provide adequate corrosion protection in stripping and/or cleaning with pH values below about 9.

U.S. Pat. No. 5,496,491 to Ward, which is incorporated herein by reference, discloses a photoresist stripping composition comprising a basic amine, a polar solvent and an inhibitor, which is the reaction product of an alkanolamine and a bicyclic compound. However, aliphatic are not disclosed as inhibitors.

U.S. Pat. No. 5,597,420 to Ward, which is herein incorporated by reference discloses a stripping composition free of hydroxylamine compounds which consists essentially of moethanolamine and water together with aromatic corrosion inhibitors.

U.S. Pat. No. 5,707,947 to Ward, which is herein incorporated by reference, discloses organic stripping compositions which can be used with the corrosion inhibitors of the present invention.

U.S. Pat. No. 4,617,251 to Sizensky, which is herein incorporated by reference, discloses stripping compositions in which inhibitors of the present invention can be utilized.

U.S. Pat. Nos. 5,334,332 and 5,275,771 to Lee, which are herein incorporated by reference, disclose aqueous and organic stripping compositions containing hydroxylamines in which the inhibitors of the present invention can be utilized.

Publication WO 98/36045 of EKC Technology, Inc. discloses a composition for removal of chemical residues from metal or dielectric surfaces or for chemical mechanical polishing of copper in an aqueous solution having a pH between 3.5 and 7 which contains a mono-, di-, or trifunctional organic acid and a buffering amount of amine, hydroxylamine or hydrazine compound. These compositions contain oxidizing agents. It is, therefore, highly desirable to provide stripping compositions that exhibit substantially little human or environmental toxicity, are water miscible and are biodegradable. It is also desirable to provide stripping compositions that are substantially non-flammable, non-corrosive, evidence relatively little toxicity to humans as well as being environmentally compatible.

In addition, it would be desirable to provide photoresist stripping compositions that have a high degree of stripping efficacy, particularly at lower temperatures than generally required with prior stripping compositions.

It is also highly desirable that photoresist stripping compositions be provided that exhibit substantially no corrosive effects on the substance.

It is further desirable to provide a stripping and cleaning composition with a high water content so as to efficiently remove inorganic residue.

### SUMMARY OF THE INVENTION

The present invention relates to basic stripping and/or cleansing compositions containing organic polar solvents having improved corrosion inhibition and a lower etch rate.

Accordingly, there is provided an aliphatic dicarboxylic acid inhibitor of the general formula.

HOOC—R—COOH

Wherein R is an alkyl group of 1-3 carbon atoms, an alkylene group of 1-3 carbon atoms, a hydroxyalkyl group of 1-3 carbon atoms or a dihydroxylalkyl group of 1-3 carbon atoms, or the anyhydrides thereof in a corrosion inhibitory effective amount.

Advantageously, the stripping and cleaning compositions contain water and basic amines including hydroxylamines at a basic pH of at least 8.

The compositions of the invention are particularly useful for removing photoresists and residues on substrates.

It is a general object of the invention to provide a corrosion inhibitor for stripping compositions for photoresists which maintain an acceptable level of corrosion inhibition in the presence of high levels of water.

It is a further object of the invention to provide an aqueous stripping and cleaning composition for aluminum and copper substrates which have a high stripping and cleaning efficacy.

It is still a further object of the invention to provide corrosion inhibitors for semi-aqueous photoresist stripping compositions which are less expensive and are effective at low concentrations.

### BRIEF DESCRIPTION OF THE DRAWINGS

FIG. 1 shows an aluminum and copper corrosion inhibition efficiency curves at 50 degrees C. for malonic acid in DMAC/water/chlorine hydroxide cleaner solution.

FIG. 2A-E and SEM's showing stripper/cleaner performance on Via wafers with an aliphatic and aromatic inhibitors.

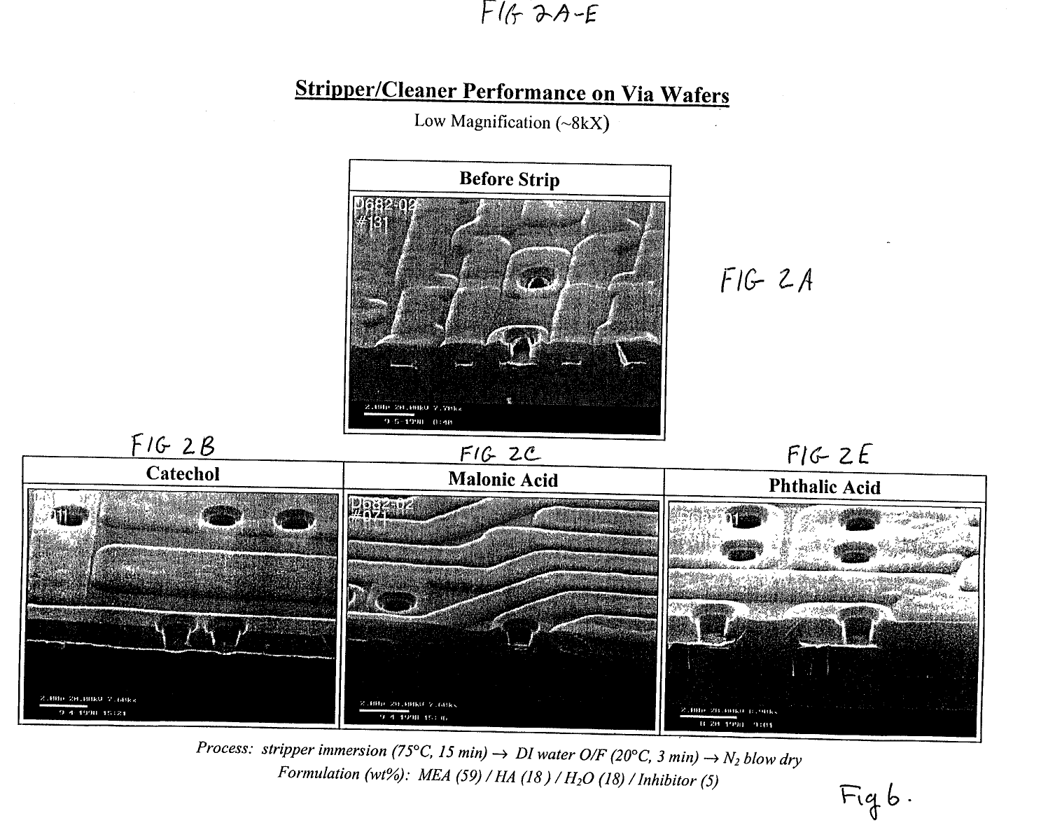

### DESCRIPTION OF THE PREFERRED EMBODIMENTS

According to the present invention there is provided novel corrosion inhibitors for use in aqueous stripping and/or cleaning compositions used in the semiconductor industry. More particularly, the present inhibitors are for use in basic stripping and/or cleaning compositions which are free of oxidants and hydrogen fluoride. The inhibitors of the invention are Aliphatic dicarboxylic compounds of the general formula:

HOOC—R—COOH

Wherein R is an alkyl group of 1-3 carbon atoms, and alkylene group of 1-3 carbon atoms, a hydroxyalkyl group of 1-3 carbon atoms, or the anhydrides thereof. The inhibitors of the invention have pK, values equal to or less than 3.4.

The preferred inhibitors of the invention are malonic acid, malonic anhydride, fumaric acid, fumaric anhydride, maleic acid, maleic anhydride, malic acid, and malic anhydride.

Corrosion inhibitors in an amount of up to about 15% by weight can be added to the stripping compositions. Preferably, the inhibitor concentration is from about 2 to 8% by weight, and most preferably, about 5% by weight.

The aliphatic bifunctional acids and their anhydrides provide corrosion protection by physabsorbtion and/or chelation similar to the mechanism for phenol derivatives. The dianions of these inhibitors can chelate with metal cations and form stable five, six and seven membered rings. The smaller molecular size of aliphatic acids allows denser surface coverage.

The organic polar solvents touch a broad range of classes, including N, N-diakylalkanoylamides, N-alkyl lactams, lactones, acetate esters of ethylene glycol ethers, acetate esters of propylene glycol ethers, aliphatic amides, cyclic aliphatic sulfones, esters of dibasic acids, cyclic ketones, sulfoxides, ether alcohols and mixtures thereof Advantageously, useful solvents include dimethyl sulfoxide, N,N-dimethylacetamides, N-methyl-2-pyrrolidinone, γ-butyrolactone, isophrone, carbitol acetate, methyl acetoxypropane, aliphatic amides, cyclic heterocyclics, dimethyl adipate, dimethyl glutarate, tetrahydrofuryl alcohol, and the like.

The alkanolamines suitable for use in the present invention are miscible with the hydroxylamine and are preferably water-soluble. Additionally, the alkanolamines useful in the present invention preferably have relatively high boiling points, such as, for example 100 degrees C. or above, and a high flash point, such as for example 45 degrees C. or above. Suitable alkanolamines are primary, secondary or tertiary amines and are preferably monoamines, diamines or triamines, and, most preferably monoamines. The alkanol group of the amines preferably has 1 to 5 carbon atoms.

Preferred alkanolamines suitable for use in the present invention can be represented by the chemical formula

R₁R₁—N—CH₂CH₂—O—R₃

wherein R₁ and R₂ can be H, CH₃, CH₃CH₂ or CH₂CH₂OH and R₃ is CH₂CH₂OH.

Examples of suitable alkanolamines include monoethanolamine, diethanolamine, triethanolamine, tertiarybutyldiethanolamine isopropanolamine, 2-amino-1-propanol, 3-amino-1-propanol, isobutanolamine, 2-amino-2-ethoxyethanol, and 2-amino-2-ethoxypropanol.

Other polar solvents suitable for use in the stripping composition of the present invention include ethylene glycol, ethylene glycol alkyl ether, diethylene glycol alkyl ether, triethylene glycol alkyl ether, propylene glycol, propylene glycol, propylene glycol alkyl ether, dipropylene glycol alkyl ether, tripropylene glycol alkyl ether, N-substituted pyrrolidone, ethylenediamine, and ethylenetriamine. Additional polar solvents as known in the art can also be used in the composition of the present invention.

Both of the anhydrides and the aliphatic dicarboxylic acid inhibitors are not utilized in acidic compositions containing an oxidizing compound, for example, hydroxylamine in the acidic medium.

The compositions of the invention are especially useful and advantageous for numerous reasons among which may be mentioned the following. The stripping compositions are water miscible, non-corrosive, non-flammable and of low toxicity to humans and the environment. Because of the low ambient vapor pressure of the compositions they evidence substantially less evaporation than prior compositions and are non-reactive and environmentally compatible.

The compositions may be recycled for multiple use or easily disposed of in an environmentally safe manner without the necessity for burdensome safety precautions. Likewise, a portion of the stripped coatings may be readily removed as solid and collected for easy disposal. The stripping compositions of this invention evidence higher stripping efficiency at lower temperatures for a wide variety of coatings and substrates. Moreover, the stripping compositions are easily prepared by simply mixing the components at room temperature and thus require no special human or environmental safety precautions. Furthermore, the components of the stripping compositions of this invention provide synergistic stripping action and permit readily and substantially complete removal of coatings from substrates.

The process of the invention is carried out by contacting a substrate containing an organic or metal-organic polymer, inorganic salt, oxide, hydroxide or complex or combination thereof as a film or residue, (e.g. sidewall polymer (SWP)), with the described stripping composition. The actual conditions, e.g., temperature, time, etc., depend on the nature and thickness of the complex (photoresist and/or SWP) material to be removed, as well as other factors familiar to those skilled in the art. In general, for stripping, the substrate in contacted or dipped into a vessel containing the stripping composition at an elevated temperature, preferably between 25-80 degrees C. for a periods of about 1-15 minutes and then washed with water.

Representative organic polymeric materials include positive photoresists, electron beam resists, X-ray resists, ion beam resists, and the like. Specific examples of organic polymeric materials include positive resists containing phenolformaldehyde resins or poly (p-vinylphenol), polymethylmethacrylate-containing resists, and the like. Examples of plasma processing residues side wall polymers (SWP) including among others, metal-organic complexes and/or inorganic salts, oxides, hydroxides or complexes which form films or residues either alone or in combination with the organic polymer resins of a photoresist. The organic materials and/or SWP can be removed from conventional substrates known to those skilled in the art, such as silicon, silicon dioxide, aluminum, aluminum alloys, copper, copper alloys, etc.

Examples illustrating the removal of a coating from a substrate under varying conditions are described further below. The following examples are provided to further illustrate the invention and are no intended to limit the scope of the present invention.

### EXAMPLE

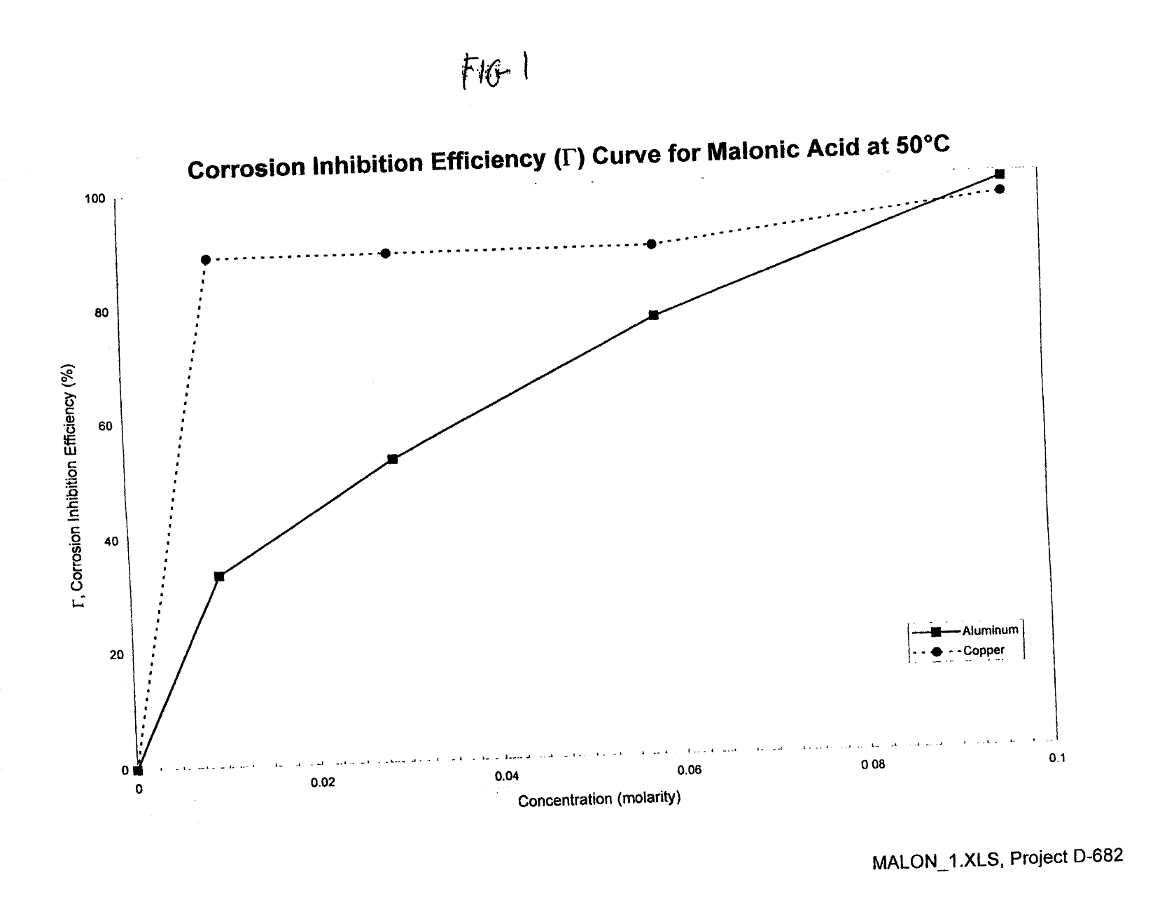

An experiment was run to determine the quantitative corrosion inhibition efficiency data for aluminum and copper at 50 degrees C. Metal etch rates were determined using a Veeco FPP5000 electrical probe system, which determines metal film thickness through resistivity measurements, and blanket metal films on silicon wafers. All test wafers contained 1200 A of thermal oxide underneath the metal film. Γ is a quantitative measure of the effectiveness of the corrosion inhibitor and varies from 0% (ineffective) to 100% (no corrosion). Values<0% denote enhanced corrosion, most likely due to increased solubility of the chelation product in the solvents tested. The order fro increasing corrosion inhibition for aluminum and copper films in the stripper/cleaner solution comprised of dimethyl acetamide (DMAC), water, and 45% choline hydroxide (wt % of 64/30/6) is; 8-HQ<catechol<pyrogallol ethyl gallate<gallic acid=benzoic acid<phthalic acid/anhydride. The fact that benzoic acid provides the same protection as gallic acid, indicates that the carboxylic acid group is involved in corrosion inhibition. The fact that ethyl gallate did not provide the same level of corrosion inhibition as gallic acid also indicates that the carboxylic acid group is needed for maximum corrosion inhibition. When only phenolic hydroxy groups are available (i.e., catechol, pyrogallol, anf ethyl gallate) a lower level of corrosion inhibition (i.e. had a larger Γ or a lower etch rate) than catechol at a concentration of ˜0.09M in the same semi-aqueous, stripper/cleaner solvent matrix. Indeed, 1 wt % malonic acid provided better corrosion inhibition for aluminum and copper than 5 wt % of 8-HQ, catechol, pyrogallol, gallic acid, benzoic acid and benzotriazole. FIG. 1 contains aluminum and copper corrosion inhibition efficiency curves at 50 degrees C. for malonic acid in a DMAC/water/choline hydroxide stripper/cleaner solution having a pH of at least 8.5, preferably 9 to 11. The concentrations of malonic acid were varied from 0 to 0.096M. An extremely sharp rise in efficiency was observed for copper corrosion inhibition and a more gradual increase in efficiency was observed for aluminum corrosion inhibition as the concentration of malonic acid was increased. At malonic acid concentration of 0.096M, the corrosion inhibition efficiency was >95% for both aluminum and copper. The results are shown in Table 1.

TABLE 1
Corrosion Inhibitor Efficiency (Γ) at 50 degrees C.
For Al and Cu Films
DMAC/H₂O/Choline Hydroxide Matrix

| Inhibitor | FW | PKₐ | Conc. (M) | Γ_{Al} (%) | Γ_{Cu} (%) | Conc. (M) | Γ_{Al} (%) | Γ_{Cu} (%) |
|---|---|---|---|---|---|---|---|---|
| 8-HQ | 145 | 9.51 | 0.069 | 50 | −907 | 0.34 | 98 | 59 |
| Catechol | 110 | 9.85 | 0.091 | 50 | 70 | 0.45 | 98 | −104 |
| Pyrogallol | 126 | −9.80 | 0.079 | 50 | 33 | 0.40 | 99.8 | 26 |
| Gallic Acid | 170 | 4.41 | 0.059 | 50 | 0 | 0.29 | 99.9 | −3 |
| Benzotriazole | 119 | — | 0.084 | 10 | 26 | 0.42 | 100 | 33 |
| Malonic Acid | 104 | 2.83 | 0.096 | 99 | 85 | 0.48 | 99.8 | 74 |
| Fumaric Acid | 116 | 3.03 | 0.086 | 0 | 93 | 0.43 | 99.9 | 70 |
| Maleic Acid | 116 | 1.83 | 0.086 | 77 | 89 | 0.43 | 99.9 | 63 |
| D,L Malic Acid | 134 | 3.40 | 0.075 | 77 | 48 | 0.37 | 99.9 | 44 |
| Benzoic Acid | 112 | 4.19 | 0.082 | 50 | 78 | 0.41 | 99.9 | 44 |
| Phthalic Acid | 166 | 2.89 | 0.060 | 17 | 85 | 0.30 | 99.9 | 78 |
| Isophthalic Acid | 166 | 3.54 | 0.060 | 50 | 78 | 0.30 | 100 | 85 |
| [Phthalic] Acid | 152 | — | 0.066 | 50 | 89 | 0.33 | 100 | 85 |

FW and pKₐ were from CRC tables.
Γ = (1 − ER/ER₀) × 100% which is a quantitative measure of the effectiveness of the inhibitor ranging form 0 to 100.
Etch rates determined for blanket films with a Veeco 5000FFP four point probe.
Solutions were run with magnetic stir agitation, 3′ water rinse, and N₂ dry.

What is claimed

1. In a basic hydrogen fluoride free cleaning composition for removal of organic and inorganic materials, said composition having a pH of at least 8.5 and consisting of an aliphatic corrosion inhibitor, water and an organic polar solvent, the improvement which comprises said composition having an effective amount of an aliphatic corrosion inhibitor of the general formula: HOOC—R—COOh wherein R is an alkyl group of 1-3 carbon atoms.

2. The composition of claim 1 comprising at least about 25% by weight water.

3. The composition of claim 2 wherein said water content is about 30-95% by weight.

4. The composition of claim 1 wherein said inhibitor is selected from the group consisting of malonic acid, fumaric acid, maleic acid and malic acid.

5. The composition of claim 1 including hydroxylamine.

6. The composition of claim 1 wherein said polar solvent is dimethyl acetamide.

7. A basic stripping and cleaning composition consisting essentially of about 59% by weight monethanolamine, about 18% by weight hydroxylamine, about 18% by weight water and about 5% by weight of malonic acid, said comosition having a pH of greater than 8.5.

8. A process for removing a coating from a coated substrate comprising applying to said coated substrate a stripping and cleaning effective amount of the composition of claim 1, permitting said stripping composition to reside on said coated substrate for a stripping effective period of time and removing the coating from said substrate.

9. A process for removing a coating from a coated substrate comprising applying to said coated substrate a stripping and cleaning effective amount of the composition of claim 2, permitting said stripping composition to reside on said coated substrate for a stripping effective period of time and removing the coating from said substrate.

10. A process for removing a coating from a coated substrate comprising applying to said coated substrate a stripping and cleaning effective amount of the composition of claim 3, permitting said stripping composition to reside on said coated substrate for a stripping effective period of time and removing the coating from said substrate.

11. A process for removing a coating from a coated substrate comprising applying to said coated substrate a stripping and cleaning effective amount of the composition of claim 6, permitting said stripping composition to reside on said coated substrate for a stripping effective period of time and removing the coating from said substrate.

12. A process for removing a coating from a coated substrate comprising applying to said coated substrate a stripping and cleaning effective amount of the composition of claim 7, permitting said stripping composition to reside on said coated substrate for a stripping effective period of time and removing the coating from said substrate.
